(19) United States
(12) Patent Application Publication
(10) Pub. No.: US 2012/0296742 A1
(43) Pub. Date: Nov. 22, 2012

(54) ADVERTISING UTILIZING DEVICE-TO-DEVICE INTERACTIONS

(75) Inventors: Pritesh Patwa, Redmond, WA (US); Martin M. Markov, Bellevue, WA (US); Wook Jin Chung, Kirkland, WA (US)

(73) Assignee: MICROSOFT CORPORATION, Redmond, WA (US)

(21) Appl. No.: 13/109,725

(22) Filed: May 17, 2011

(51) Int. Cl. G06Q 30/00

(52) U.S. Cl. 705/14.54; 705/14.4

(57) ABSTRACT

Methods and systems for enabling an advertiser to utilize device-to-device interactions to track word-of-mouth advertising and to take advantage of differentiated pricing schemes based on a quantity of an item are provided. An advertisement is received on a first device, and the first device identifies a second device that is receptive to interaction. The first device interacts with the second device. Concurrently with the interaction, an advertisement identifier associated with the advertisement is communicated from the first device to the second device. The advertisement identifier enables the second device to receive the advertisement.

### BACKGROUND

Advertisers desire a way to track a performance of an advertising campaign. But advertisers are currently limited to conventional metrics that measure performance such as cost per impression, cost per click, cost per action, and the like. However, these metrics fail to capture word-of-mouth advertising. Word-of-mouth advertising is a powerful and cost-effective way to advertise a product, and advertisers would gladly reward customers who engage in this practice. But because advertisers are unable to track word-of-mouth advertising, they are currently unable to reward customers who engage in this type of advertising.

Additionally, advertisers do not typically target individual customers with differentiated pricing schemes based on a quantity of an item to be sold. This is mainly because it is difficult for individual customers to aggregate in sufficient quantities to be able to take advantage of the differentiated pricing scheme. This is especially true in an offline setting. For example, if a customer knows that a local retailer of electronic goods is offering a deal where five televisions will be sold for $1000 each (instead of the usual sales prices of $1500 per television), the customer still has to aggregate four other people in order to take advantage of the deal. Presently there is no easy way for the customer to find other people willing to take advantage of this deal in an offline setting. The result is that advertisers rarely use differentiated pricing schemes when advertising a product targeted to individual customers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable media for, among other things, enabling an advertiser to reward customers who engage in word-of-mouth advertising through device-to-device interactions. For example, a customer may receive an advertisement with an associated reward on his mobile device. The customer can then interact with other mobile devices in such a way as to facilitate the dissemination of the advertisement. After the customer has interacted with a certain number of mobile devices, the customer is able to utilize the reward. In addition, the present invention further leverages device-to-device interactions by enabling an advertiser to create advertisements that take advantage of bulk buying concepts. In this case, a customer can aggregate a set of buyers by utilizing device-to-device interactions. Once the required number of buyers is aggregated, the buyers can buy the items in bulk and take advantage of reduced pricing.

### BRIEF DESCRIPTION OF THE DRAWINGS

The present invention is described in detail below with reference to the attached drawing figures, wherein:

FIG. 1 is a block diagram of an exemplary computing system environment for facilitating advertising utilizing device-to-device interactions suitable for use in implementing embodiments of the present invention;

FIG. 2 depicts an illustrative process-flow diagram that depicts a method of advertising utilizing device-to-device interactions in accordance with an embodiment of the present invention;

FIG. 3 depicts an illustrative process-flow diagram that depicts a method of advertising using a differentiated pricing scheme based on a quantity of an item in accordance with an embodiment of the present invention;

FIG. 4 depicts an illustrative process-flow diagram that depicts a method of advertising using device-to-device interactions in accordance with an embodiment of the present invention;

FIG. 5 depicts an illustrative flow diagram that depicts a method of advertising utilizing device-to-device interactions in accordance with an embodiment of the present invention;

FIG. 6 depicts an illustrative flow diagram that depicts a method of advertising using a differentiated pricing scheme based on a quantity of an item in accordance with an embodiment of the present invention;

FIG. 7 depicts an illustrative flow diagram that depicts a method of advertising using device-to-device interactions in accordance with an embodiment of the present invention; and

FIG. 8 is a block diagram of an exemplary computing environment suitable for use in implementing embodiments of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer-readable media for, among other things, enabling an advertiser to reward customers who engage in word-of-mouth advertising through device-to-device interactions. For example, a customer may receive an advertisement with an associated reward on his mobile device. The customer can then interact with other mobile devices in such a way as to facilitate the dissemination of the advertisement. After the customer has interacted with a certain number of mobile devices, the reward is enabled and the customer is able to use the reward. In addition, the present invention further leverages device-to-device interactions by enabling an advertiser to create advertisements that take advantage of bulk buying concepts. In this case, a customer can aggregate a set of buyers by utilizing device-to-device interactions. Once the required number of buyers is aggregated, the buyers can buy the items in bulk and take advantage of reduced pricing.

Accordingly, in one embodiment, the present invention is directed toward computer-readable media having computer-executable instructions embodied thereon that, when executed, facilitate a method of advertising utilizing device-to-device interactions. An advertisement is communicated to a first device associated with a first user; the advertisement has an associated reward that is enabled at the first device after the advertisement has been communicated to a predefined number of devices. Incident to an interaction between the first device and a second device associated with a second user, a request is received from the second device to communicate the advertisement to the second device. The advertisement is communicated to the second device. After the advertisement has been communicated to the predefined number of devices, each communication of the advertisement incident to an interaction between the first device and a respective one of the predefined number of devices, the reward is enabled at the first device.

In another embodiment, the present invention is directed toward computer-readable media having computer-executable instructions embodied thereon that, when executed, facilitate a method of advertising using a differentiated pricing scheme based on a quantity of an item. An advertisement that includes the differentiated pricing scheme based on the quantity of the item is communicated to a first device associated with a first user; the advertisement is associated with a retailer. An indication is received that the first device has interacted with a second device associated with a second user. Information associated with the second user is stored; the information includes an identity of the second user and payment information associated with the second user. The differentiated pricing scheme is enabled on the first device, and the identity of the second user along with the payment information associated with the second user is communicated to the retailer associated with the advertisement.

In yet another embodiment, the present invention is directed toward computer-readable media having computer-executable instructions embodied thereon that, when executed, facilitate a method of advertising utilizing device-to-device interactions. An advertisement is received at a first device associated with a first user. The first device identifies a second device associated with a second user that is receptive to interaction, and the first device interacts with the second device. Concurrently with the interaction, the first device communicates an advertisement identifier associated with the advertisement to the second device. The advertisement identifier enables the second device to receive the advertisement.

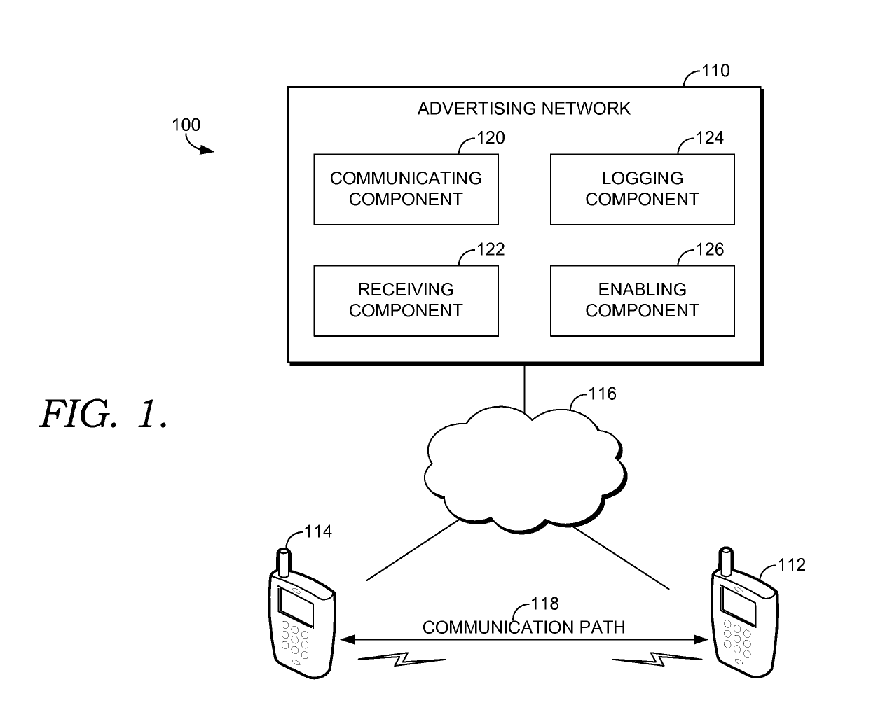

Turning now to FIG. 1, a block diagram is illustrated that shows an exemplary computing system environment 100 for use in facilitating advertising utilizing device-to-device interactions in accordance with an embodiment of the present invention. The computing system environment 100 shown in FIG. 1 is merely an example of one suitable system and is not intended to suggest any limitation as to the scope of use or functionality of embodiments of the present invention. Neither should the computing system environment 100 be interpreted as having any dependency or requirement related to any single module/component or combination of modules/components illustrated therein.

The computing system environment 100 includes an advertising network 110, a first device 112 associated with a first user, and a second device 114 associated with a second user. Each of the components 110, 112, and 114 may be in communication with each other via a network 116. The network 116 may include, without limitation, one or more local area networks (LANs) and/or wide area networks (WANs). Such networking environments are commonplace in offices, enterprise-wide computer networks, intranets and the Internet. Accordingly, the network 116 is not further described herein.

The first device 112 and the second device 114 may interact with one another through, for example, some type of communication path 118. The communication path 118 may utilize any number of communication technologies. For example, the communication path 118 may utilize short-range wireless radio-frequency communication, near-field communication, a LAN, a WAN, and/or a cellular phone network.

The advertising network 110 may comprise any Web-based search and advertisement engine. The first device 112 and the second device 114 may comprise any device capable of communicating with the advertising network 110 through, for example, the network 116, and/or with each other through, for example, the communication path 118. In one aspect, the first device 112 and the second device 114 may comprise any type of smart phone or cellular phone capable of running applications. In another aspect, the first device 112 and the second device 114 are equipped with accelerometers for detecting physical movements of the first device 112 and/or the second device 114.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

Components of the advertising network 110, the first device 112, and the second device 114 may include, without limitation, a processing unit, internal system memory, and a suitable system bus for coupling various system components, including one or more data stores for storing information (e.g., files and metadata associated therewith). Each of the advertising network 110, the first device 112, and the second device 114 typically includes, or has access to, a variety of computer-readable media. By way of example, and not limitation, computer-readable media may include computer-storage media and communication media. In general, communication media enables each computing device to exchange data via a network, e.g., the network 116, or a communication path, e.g., the communication path 118. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

The computing system environment 100 is merely exemplary. For example, while the advertising network 110 is illustrated as a single unit, it will be appreciated that the advertising network 110 is scalable. For example, the advertising network 110 may in actuality include a plurality of computing devices in communication with one another. Moreover, a data store (not shown), or portions thereof, may be included within, for instance, the advertising network 110, the first device 112, and the second device 114 as a computer-storage medium. The single unit depictions are meant for clarity, not to limit the scope of embodiments in any form.

As shown in FIG. 1, the advertising network 110 comprises a communicating component 120, a receiving component 122, a logging component 124, and an enabling component 126. In some embodiments, one or more of the components 120, 122, 124, and 126 may be implemented as stand-alone applications. In other embodiments, one or more of the components 120, 122, 124, and 126 may be integrated directly into the operating system of a computing device. The components 120, 122, 124, and 126 illustrated in FIG. 1 are exemplary in nature and in number and should not be construed as limiting. Any number of components may be employed to achieve the desired functionality within the scope of embodiments hereof.

The communicating component 120 is configured to communicate (via the network 116) advertisements and/or information to the first device 112 and/or the second device 114. The communicating component 120 may communicate a plurality of advertisements at the same time to the first device 112 and/or the second device 114, or may communicate one advertisement at a time. In one aspect, the communicated advertisement may contain an associated reward that is enabled after the advertisement has been communicated to a predefined number of devices. Although the communicating component 120 may communicate advertisements and/or information to both the first device 112 and/or the second device 114, the following discussion will be restricted to the first device 112 for purposes of simplicity. In one aspect, the advertisement is communicated subsequent to some type of user interaction with the first device 112. For example, the first user may initiate a search query on the first device 112. The advertisement(s) may be communicated to the first device 112 along with the results of the search query. As well, the first user may request a Web page on the first device 112. The advertisement(s) may be communicated along with the requested Web page to the first device 112. In another aspect, the first user may interact with a computer application on the first device 112. The advertisement(s) may be communicated to the first device 112 as a result of the user interaction with the computer application. Additionally, an advertisement may be communicated to the first device 112 upon receiving a request from the first device 112 that the advertisement be communicated.

Alternatively, the communicating component 120 may push advertisements to the first device 112 without any user interaction with the device. Advertisements that are pushed to the first device 112 may be based on targeting information associated with the first user. In one aspect, the communicating component 120 determines the type of advertisements pertaining to a product category that are already present on the first device 112. After making the determination, the communicating component 120 pushes advertisements related to that product category to the first device 112. For example, it may be determined that an advertisement from a pizza chain (i.e., the product category is food, and, specifically, pizza) is present on the first device 112. Based on this determination, the communicating component 120 may push advertisements from a competing pizza chain.

In yet another aspect of the invention, the communicating component 120 first determines whether an advertisement is already present on the first device 112. The advertisement may already be present on the first device 112 because it has been previously communicated to the first device 112 by the advertising network 110. Or, alternatively, the advertisement may be present on the first device 112 because it has been communicated to the first device 112 by another device. If the advertisement is already present on the first device 112, the advertising network 110 will not re-communicate the advertisement but may communicate any updates to the advertisement, any status changes associated with the advertisement, or, possibly, any reward components associated with the advertisement. For example, the communicating component 120 may communicate a message that the advertisement has expired.

Additionally, the communicating component 120 may communicate information to the first device 112 concerning a number of interactions between the first device 112 and a plurality of other devices. In one aspect, the communicating component 120 may communicate information concerning the number of interactions between the first device 112 and the plurality of other devices to any device within the plurality of devices. The information concerning the number of interaction between the first device 112 and the plurality of other devices may be displayed as a visual indicator on the first device. For example, the first device may display a message that states how many interactions have occurred and how many interactions are still needed before a reward is enabled. In another aspect, the visual indicator may be displayed on each device that the first device 112 has interacted with. The communicating component 120 may also communicate information concerning the presence of purchase groups. This will be explained in greater depth below. Any and all such variations, and any combination thereof, are contemplated to be within the scope of embodiments of the present invention.

The receiving component 122 is configured to receive requests and/or information from the first device 112 and/or the second device 114. In one aspect, the receiving component 122 receives a request from the second device 114 that an advertisement be communicated to the second device 114. Still further, the request may be in the form of an advertisement identifier that is received by the receiving component 122 from the second device 114. The advertisement identifier identifies which advertisement should be communicated to the second device 114 via, for example, the communicating component 120.

In addition, the receiving component 122 is configured to receive information from the first device 112 and/or the second device 114. The information may concern whether the second device 114 has interacted with the first device 112 or other devices, or the information may concern the status of a particular advertisement. The information may include the identities of the first user and/or the second user. The information may also include payment information associated with the first user and/or the second user. In one aspect of the invention, the identity of the first user and/or the second user and payment information associated with the first user and/or the second user may be assigned a code by the advertising network 110, and, in turn, the code may be communicated to the first device 112 and/or the second device 114 via the communicating component 120. Although the receiving component 122 is discussed with reference to the first device 112 and the second device 114, it is to be understood that the receiving component 122 is configured to receive information and/or requests from any number of devices.

The logging component 124 is configured to log interactions between the first device 112 and the second device 114. For example, the receiving component 122 may receive information from the first device 112 and/or the second device 114 that an interaction has occurred between the devices. The logging component 124 then logs the interaction. In one aspect, the logged interactions may be stored as a new type of advertising metric that takes into account the number of device-to-device interactions related to an advertisement. In essence, this metric could be thought of as a “cost per word-of-mouth” metric and could be used as a measure of the cost-effectiveness of word-of-mouth advertising using device-to-device interactions.

As mentioned above, in one aspect, a reward associated with an advertisement may be enabled after the advertisement has been communicated to a predefined number of devices. In one aspect, the number of interactions logged by the logging component 124 provides an indication of how many times the advertisement has been communicated. Thus, once the number of interactions logged by the logging component 124 reaches the predefined number, the reward associated with the advertisement is enabled on the first device 112. In another aspect, a certain number of interactions between devices must be logged before a differentiated pricing scheme based on a quantity of an item is enabled on the first device 112. The logging component 124 is configured to log interactions between the first device 112 and any number of devices. In addition, the logging component 124 is configured to log interactions between any set of devices as long as the interactions pertain to the advertisement or the differentiated pricing scheme on the first device 112.

An interaction between devices, for example between the first device 112 and the second device 114, may be thought of as an indication that the users of the devices are agreeing upon something mutual. For example, the users could agree to share an advertisement or participate in a differentiated pricing scheme. In essence the interaction can be thought of as a handshake or a contract with an offer and an acceptance. For the interaction to occur there must be an initiator of the interaction and a willing recipient of the interaction. In other words, the recipient of the interaction cannot receive the interaction without consent.

The interaction between the devices can occur through a variety of mechanisms. In one aspect, the first device 112 and the second device 114 are within close proximity of each other at the time the interaction occurs. The interaction can involve an actual touching of the two devices—a concept known as “bumping.” For example, the first device 112 may be placed on top of the second device 114, or the two devices may simply be touched together. Or the first user may shake the first device 112 to initiate the interaction, and the second user may shake the second device 114 to accept the interaction. In each of these cases, an accelerometer present in the first device 112 and the second device 114 may sense the physical movement of the phones and relay the information to the advertising network 110. Interactions that require that the two devices be within a close proximity of each other can help to foster trust between the parties involved in the transaction. The interaction may utilize the communication path 118. The communication path 118 takes advantage of short-range wireless radio-frequency communication, near-field communication, or a local area network. As can be seen, this type of device-to-device interaction can occur in an offline setting.

Alternatively, the first device 112 may interact with the second device 114 when the two devices are not within a close proximity of each other—a concept known as “remote bumping.” For example, the devices may interact with each other via some type of social network utilizing a wide area network as the communication path 118. In a representative scenario involving interactions in a social network setting, the first user could offer an invitation to a group of friends to receive an advertisement about a great new product or to participate in a differentiated pricing scheme. Each of the friends would receive the invitation and could elect to accept the invitation. This would be on a first-come, first-served basis. For instance, the first user may be required to share the advertisement with 10 friends in order for a reward associated with the advertisement to be enabled. The first user extends an invitation to 15 friends; the first 10 friends who accept the invitation would receive the advertisement.

In another aspect of the invention, the first user may select an interaction or “bump” button on the first device 112, in this case, a mobile phone. The first user can then select a group of contacts on the first device 112. The second user would receive an indication that a bump is waiting through, for example, a text message or an email. The second user could then acknowledge the bump and receive, for example, an advertisement or a differentiated pricing scheme on the second device 114, also a mobile phone. This type of interaction would utilize a cellular phone network as the communication path 118.

The actual interaction between the devices often involves a transfer of data between the devices. For example, the first device 112 may transfer information about an advertisement to the second device 114. In one aspect, this information may be in the form of an advertisement identifier; in another aspect, it may be the advertisement itself. A status of the advertisement may also be transferred from the first device 112 to the second device 114. In another aspect, information concerning a differentiated pricing scheme may be transferred from the first device 112 to the second device 114, or a code that corresponds to an identity of a user and payment information associated with that user may be transferred between devices.

Turning back to FIG. 1, the advertising network 110 also has an enabling component 126. In one aspect, the enabling component 126 is configured to enable a reward associated with an advertisement. For example, the first device 112 may receive the advertisement with the associated reward. To take advantage of the reward, the first user is required to interact with and communicate the advertisement to five other devices. After the five communications have occurred incident to the interactions, the enabling component 126 enables the reward on the first device 112. In another example, the first user may wish to take advantage of a differentiated pricing scheme based on a quantity of an item. The differentiated pricing scheme requires that five people commit to buying the items at the indicated price. After the advertising network 110 has logged five interactions, through, for example, the logging component 124, the enabling component 126 will enable the differentiated pricing scheme on the first device 112. Both of these processes will be explained in greater depth below. In another aspect of the invention, the enabling component 126 is configured to enable the reward on all devices that have received the advertisement.

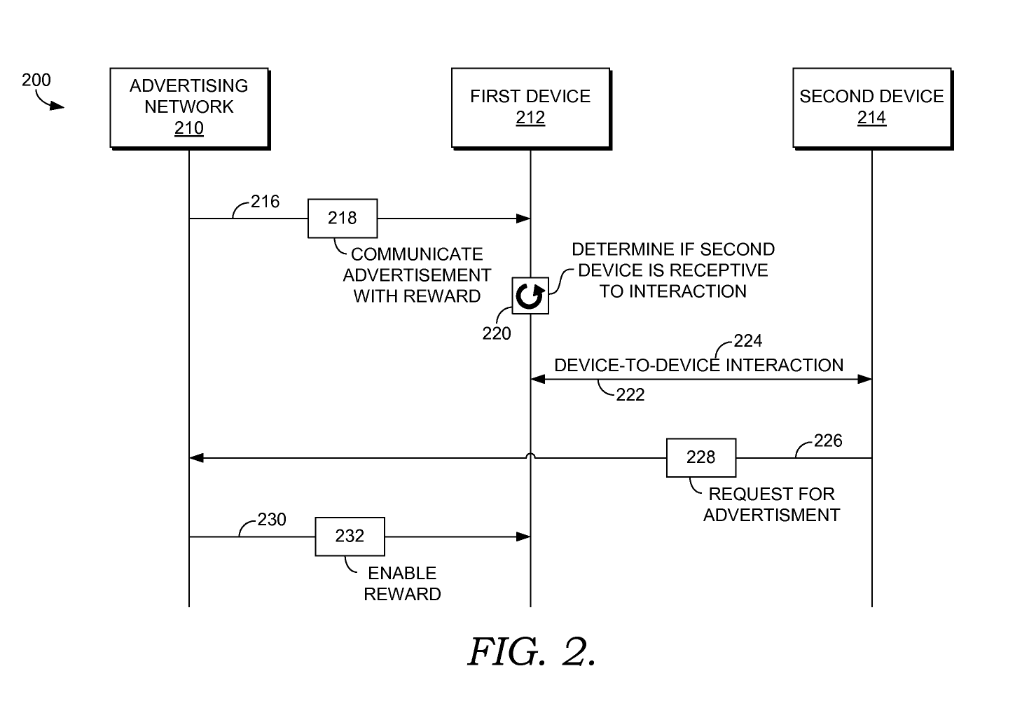

Turning now to FIG. 2, an illustrative process-flow diagram is depicted of a method of advertising utilizing device-to-device interactions. The process-flow diagram is referenced generally by the numeral 200. FIG. 2 includes an advertising network 210, a first device 212, and a second device 214.

The advertising network 210 may be any Web-based search and advertisement engine such as, for example, the advertising network 110 of FIG. 1. Like above, the first device 212 and the second device 214 are capable of communicating with the advertising network 210 and with each other through, for example, a communication path such as the communication path 118 of FIG. 1. The first device 212 and the second device 214 may be the first device 112 and the second device 114 of FIG. 1. The first device 212 is associated with a first user and the second device 214 is associated with a second user. In one aspect, the first device 212 and the second device 214 may comprise any type of smart phone or cellular phone capable of running applications.

At step 216 of FIG. 2, an advertisement 218 with an associated reward is communicated to the first device 212. The reward is enabled at the first device 212 after the advertisement 218 has been communicated to a predefined number of devices. In one aspect, a retailer or advertiser associated with the reward determines how many devices the advertisement 218 should be communicated to in order for the reward to be enabled at the first device 212. The retailer or advertiser may be charged by the advertising network 210 each time the advertisement 218 is communicated to a device.

At step 220, the first device 212 determines if the second device 214 is receptive to an interaction. In one aspect, this determination is made via a communication path between the first device 212 and the second device 214. The communication path may be established via short-range wireless radio-frequency communication, near-field communication, a local area network, a wide area network, or a cellular phone network.

At step 222, an interaction 224 occurs between the first device 212 and the second device 214. The interaction 224 can involve a transfer of information from the first device 212 to the second device 214. The transferred information may include an advertisement identifier that identifies the advertisement 218. The advertisement identifier enables the second device 214 to receive the advertisement 218 from, for example, the advertising network 210. The transferred information may include information as to whether the advertisement 218 is still active, how many interactions are needed to enable the reward, and other information related to the advertisement 218.

At step 226, incident to the interaction 224 between the first device 212 and the second device 214, a request 228 is received by the advertising network 210 from the second device 214 to communicate the advertisement 218 to the second device 214. The request 228 from the second device 214 may be in the form of the advertisement identifier received by the second device 214 during the interaction 224 with the first device 212.

At step 230, the reward 232 is enabled at the first device 212. In one aspect, the reward 232 is not enabled until the advertisement 218 has been communicated from the first device 212 to the predefined number of devices, each communication of the advertisement 218 being incident to an interaction 224 between the first device 212 and a respective one of the predefined number of devices. Once the reward 232 is enabled, the first user if free to utilize the reward 232. The reward 232 may include any type of incentive reward known in the art. The retailer or advertiser may be charged by the advertising network 210 at the time the reward 232 is enabled. Thus, instead of charging the advertiser each time the advertisement 218 is communicated, the advertiser is charged after the advertisement 218 has been communicated from the first device 212 to the predefined number of devices and the reward 232 is enabled.

In another aspect of the invention, the first device 212 may interact with a third device associated with a third user (not shown). Incident to this interaction, the advertising network 210 receives a request from the third device to communicate the advertisement 218 to the third device. The advertising network 210 communicates the advertisement 218 to the third device, and, incident to communicating the advertisement 218 to the predefined number of devices, each communication of the advertisement 218 being incident to an interaction 224 between the first device 212 and a respective one of the predefined number of devices, the reward 232 is enabled at the first device 212.

In yet another aspect of the invention, the second device 214 interacts with a third device associated with a third user (not shown). Incident to this interaction, a request is received by the advertising network 210 from the third device to communicate the advertisement 218 to the third device. The advertising network 210 communicates the advertisement 218 to the third device. Incident to communicating the advertisement 218 from the second device 214 to the predefined number of devices, each communication of the advertisement 218 being incident to an interaction between the second device 214 and a respective one of the predefined number of devices, the reward 232 is enabled at the first device 212.

In still yet another aspect of the invention, incident to communicating the advertisement 218 from the first device 212 to the predefined number of devices, each communication of the advertisement 218 being incident to an interaction between the first device 212 and a respective one of the predefined number of devices, the reward 232 is enabled on all of the devices and not just the first device 212. Any and all such variations, and any combination thereof, are contemplated to be within the scope of embodiments of the present invention.

Several examples are provided to better illustrate the claimed invention. These examples are illustrative in nature and are not meant to limit the invention in any way. The first example deals with the “Giant Pizza.” Company A is launching a Giant Pizza campaign. The Giant Pizza is much larger than a traditional pizza and can feed up to 15 people. Company A hopes to make the Giant Pizza a mainstay at parties or gatherings of 15 or more people. However, Company A realizes that it is not an everyday occurrence that 15 or more people gather in one place, so it comes up with an advertising campaign that is designed to encourage these types of gatherings. The campaign features the following slogan: “Get 15 in a room, bump each other, and get $15 off a Giant Pizza!” The original price of the pizza is $30.

John, a lover of pizza, sees the advertisement on his mobile phone and decides to organize a party to take advantage of the coupon. As people gather, John takes his phone and “bumps” his phone to the phone of the person standing next to him. Now the screens of both phones show the counter “2.” John continues to “bump” his phone to other phones in the room. At the point he bumps his 14^{th} phone, all 15 phones show the counter “15” and the message “Call Company A!!!” John calls Company A to order the Giant Pizza. Company A asks for the Giant Pizza coupon code. The coupon code is a 15 letter code that is split across the 15 screens. John's phone has the code “1:T” and someone else's phone as the code “2:H,” and so on. When all the codes are joined together, they spell out “T-A-S-T-E-G-I-A-N-T-P-I-Z-Z-A.” Company A delivers the pizza to the enjoyment of the party gatherers.

With respect to the Giant Pizza example, in one aspect, John would have to bump each of the 14 phones. But in another aspect of the invention, John could bump the first phone, the first phone could bump the second phone, and so on. Any and all such variations, and any combination thereof, are contemplated to be within the scope of embodiments of the present invention.

In another exemplary example, Company B wants to increase brand awareness of a clothing line, Modern Flo, that is designed for middle school kids and decide to launch an advertisement campaign that takes advantage of word-of-mouth advertising using device-to-device interactions. Company B comes up with the following advertisement: “Bump 10 friends on Modern Flo—tell them about the NEW FLO—and get 50% off your next pair of jeans. Don't know Modern Flo? No worries. Check us out here!”

Jane sees the advertisement on her phone and taps on the advertisement to see what Modern Flo is all about. She likes what she sees, so she decides to bump 10 of her friends. Jane bumps her phone to Anne. Now on Anne's screen is the same advertisement that appeared on Jane's phone. On Jane's phone, it indicates that 9 bumps remain. At this point, Anne can go off and bump 10 new people to take advantage of the advertisement on her phone. Once Jane bumps 10 of her friends, the coupon is enabled on her phone, and she gets 50% off on a pair of Modern Flo jeans. In the Modern Flo example, and unlike the Giant Pizza example, Jane is responsible for bumping all 10 people. As can be seen, the needs of the advertiser and the nature of the reward dictate which type of bumping or interacting scenario is more suitable to achieve the desired needs.

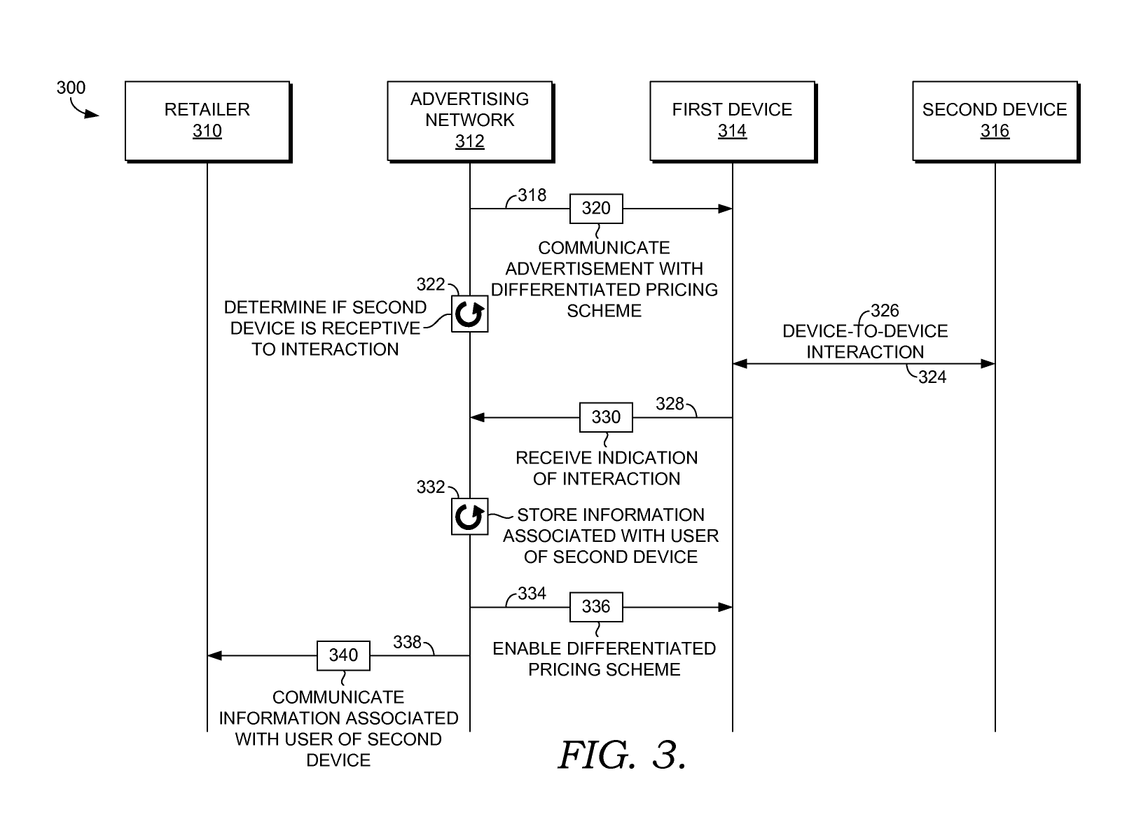

Turning now to FIG. 3, an illustrative process-flow diagram is depicted of a method of advertising using a differentiated pricing scheme based on a quantity of an item. The process-flow diagram is referenced generally by the numeral 300. FIG. 3 includes a retailer 310, an advertising network 312, a first device 314 associated with a first user, and a second device 316 associated with a second user. The advertising network 312, the first device 314, and the second device 316 may be the advertising network 210, the first device 212 and the second device 214 of FIG. 2 and, as such, no further detail concerning these devices will be set forth here. Retailer 310 may be any retailer or advertiser that wishes to use a differentiated pricing scheme based on a quantity of an item. The retailer 310 may be an online retailer or an offline retailer.

At step 318, an advertisement 320 is communicated from the advertising network 312 to the first device 314. The advertisement 320 is associated with the retailer 310 and includes a differentiated pricing scheme based on a quantity of an item. For example, the advertisement 320 may offer five televisions for $1,000 per television, or three televisions for $1,200 per television, or one television for $1,500 per television. The advertisement 320 may stipulate that the differentiated pricing scheme is only available for a certain period of time, and that the purchase of the items must occur in a single transaction instead of multiple, separate transactions. As well, the advertisement 320 may stipulate that the customers taking advantage of the deal be physically present at the retailer 310 in order to pick up the items.

In one aspect of the invention, the advertisement 320 communicated to the first device 112 also contains information regarding the presence of purchase groups associated with the differentiated pricing scheme. A purchase group typically is led by a purchase leader. The purchase leader attempts to aggregate the required number of buyers (the purchase group) to take advantage of the differentiated pricing scheme. If a purchase group already exists, the first user may elect to join the already existing purchase group by sending a request to a purchase leader of the purchase group. The request may be sent via electronic mail, text messaging, a phone call, and the like. If a purchase group does not exist, the advertisement 320 may ask if the first user would like to be a purchase leader of a purchase group. If the first user accepts this position, then the first user is responsible for aggregating the required number of buyers to take advantage of the advertisement 320 with the differentiated pricing scheme. In addition, in one aspect, the first user of the first device 314 is the only user with the authority to purchase the items.

At step 322, the first device 314 determines if the second device 316 is receptive to an interaction. In one aspect, this determination is made via a communication path between the first device 314 and the second device 316. The communication path may be established via short-range wireless radio-frequency communication, near-field communication, a local area network, a wide area network, or a cellular phone network. The communication path may be the communication path 118 of FIG. 1.

At step 324, an interaction 326 occurs between the first device 314 and the second device 316. The interaction 326 can involve a transfer of information from the first device 314 to the second device 316. The transferred information may include an acknowledgment from the second device 316 that the first user of the first device 314 is the purchase leader of the purchase group that is taking advantage of the differentiated pricing scheme. The transferred information may also include the advertisement 320 with the differentiated pricing scheme or an advertisement identifier that identifies the advertisement 320.

At step 328, the advertising network 312 receives an indication 330 of the interaction 326 between the first device 314 and the second device 316. In one aspect, the indication 330 may include information corresponding to an identity of the second user of the second device 316 along with payment information associated with the second user. The advertising network 312 may assign a code to this information and communicate the code to the first device 314. In another aspect of the invention, incident to receiving the indication 330 that the first device 314 has interacted with the second device 316, the advertising network 312 may communicate information concerning the interaction 326 to the first device 314 and the second device 316 which may be displayed as a visual indicator on the first device 314 and/or the second device 316. For example, the first device 314 may display a message stating that one interaction has occurred and four remain in order for the differentiated pricing scheme to be enabled.

At step 322, the advertising network 312 stores information associated with the second user such as the second user's identity and payment information associated with the second user. At step 334, the differentiated pricing scheme 336 is enabled at the first device 314. Upon enabling the differentiated pricing scheme 336, the first user of the first device 314 has the authority to purchase the item(s) on behalf of the second user. The differentiated pricing scheme 336 is only enabled for the advertisement 320 associated with the retailer 310.

Once the differentiated pricing scheme 336 is enabled, the first user can present the first device 314 at the retailer 310. As outlined above, the first device 314 may have a code corresponding to information associated with the second user of the second device 316. This code is communicated to the retailer 310 who, in turn, may send a request to the advertising network 312 for the identity of the second user along with payment information associated with the second user. Upon receiving the request, and at step 338, the advertising network 312 communicates the information 340 to the retailer 310; the information comprising the identity of the second user and the payment information associated with the second user. Also, upon receiving the request from the retailer 310, the advertising network 312 sends a notification to the second device 316 that the differentiated pricing scheme has been enabled and that the second user needs to pick up the item(s) at the retailer 310 by the specified time.

In another aspect, the advertising network 312 may receive an indication that the first device 314 has interacted with a third device associated with a third user. The advertising network 312 may store information associated with the third user such as an identity of the third user along with payment information associated with the third user. The differentiated pricing scheme 336 may be enabled on the first device 314 and the identity of the third user along with the payment information associated with the third user may be communicated to the retailer 310 associated with the advertisement 320.

In yet another aspect, the advertising network 312 may receive an indication that the second device 316 has interacted with a third device associated with a third user. Information may be stored by the advertising network 312, where the information includes an identity of the third user along with payment information associated with the third user. The differentiated pricing scheme 336 may be enabled on the first device 314, and the identity of the third user and the payment information associated with the third user may be communicated to the retailer 310 associated with the advertisement 320. Any and all such variations, and any combination thereof, are contemplated to be within the scope of embodiments of the present invention.

An example is provided to better illustrate the claimed invention. This is an illustrative example and is not meant to be limiting in any way. Company C is experiencing an inventory problem. It currently has 50 units of Lawnmower X that it has not sold, and the new model is due to arrive next month. The retail price of Lawnmower X is $1,800. Company C decides to come up with a differentiated pricing scheme that takes advantage of the power of device-to-device interactions in order to reduce the inventory of Lawnmower X. The advertisement reads as follows: “Lawnmower X—the ultimate lawn mowing experience—yours for $1,800. Buy 2 and get each for $1,600, Buy 3 and get each for $1,400, Buy 4 and get each for $1,200, Buy 5 and get each for $1,000.”

Jimmy sees the advertisement on his phone and would love to take advantage of the deal. He commits to buying the lawnmower and enters his payment information. The advertisement informs him that there are no existing purchase groups for the differentiated pricing scheme and asks Jimmy if he would like to be a purchase leader. Jimmy accepts the position.

Sandy sees the same advertisement on her phone and is interested. She taps on the advertisement and is informed that there is an active purchase group in her area led by Jimmy. Sandy meets Jimmy and bumps her phone to his. The action acknowledges Jimmy as the purchase leader and registers Sandy's identity along with her payment information. Both Sandy's and Jimmy's phone show the visual indicator, “2 in group, need 3 more.” Sandy knows her brother, Sam, is interested in a lawnmower. She meets with him and bumps her phone to his. This action automatically gets registered to Jimmy's phone since Sandy has acknowledged him to be the purchase leader. All phones now indicate the status of the advertisement, but Jimmy is the only person authorized to make the purchase of the lawnmowers.

Two other people join the purchase group by bumping their phones to the phones of existing members of the purchase group. When the fifth member joins, Jimmy goes to Company C and communicates the codes associated with the four other buyers in the purchase group. Company C communicates the code information to the advertising network. The advertising network passes along the needed payment information along with the identities of the other buyers who have purchased Lawnmower X. The advertising network sends a notification to the other buyers that they need to pick up Lawnmower X by a specified date. Jimmy is now ready to pick up his new lawnmower for $1,000. The other members of the purchase group come in during the following week to pick up their lawnmowers.

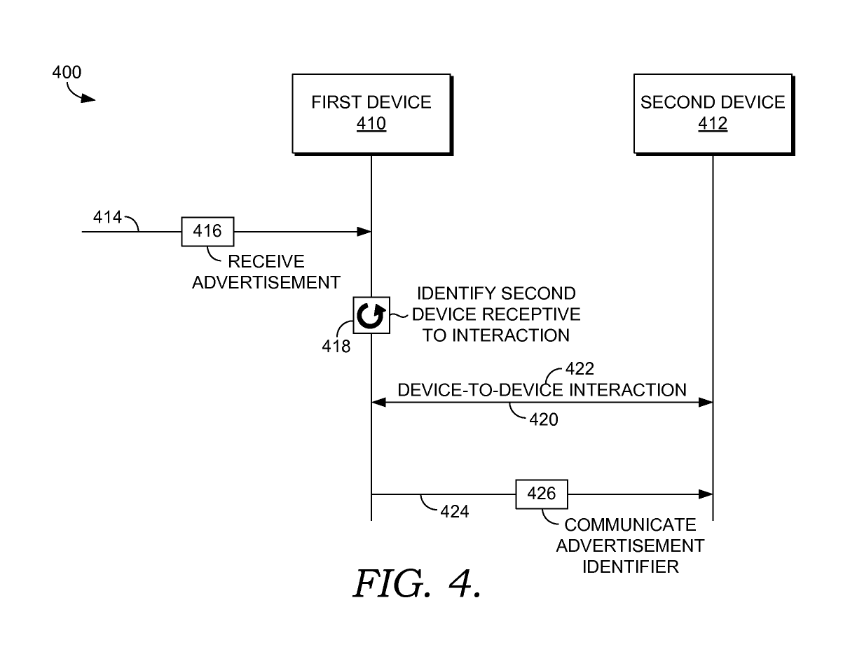

FIG. 4 is a process-flow that depicts a method of advertising using device-to-device interactions. The process-flow diagram is referenced generally by the numeral 400. FIG. 4 depicts a first device 410 associated with a first user and a second device 412 associated with a second user. The first device 410 and the second device 412 may be the first device 212 and the second device 214 of FIG. 2, or the first device 314 and the second device 316 of FIG. 3. As such, no further explanation of the first device 410 and the second device 412 is set forth here.

At step 414, an advertisement 416 is received by the first device 410. In one aspect, the advertisement 416 is received from an advertising network such as the advertising network 210 of FIG. 2 or the advertising network 312 of FIG. 3. In another aspect, the advertisement 416 is received from another device (not shown). At step 418, the first device 410 identifies that the second device 412 is receptive to interaction. This may occur through a communication path utilizing short-range wireless radio-frequency communication, near-field communication, a LAN, a WAN, or a cellular phone network. At step 420, an interaction 422 occurs between the first device 410 and the second device 412. Concurrently with the interaction 422, and at step 424, the first device 410 communicates an advertisement identifier 426 to the second device 412. The advertisement identifier 426 enables the second device 412 to receive the advertisement 416. In one aspect, the second device 412 receives the advertisement 416 from the advertising network. In another aspect, the second device 412 receives the advertisement 416 directly from the first device 410.

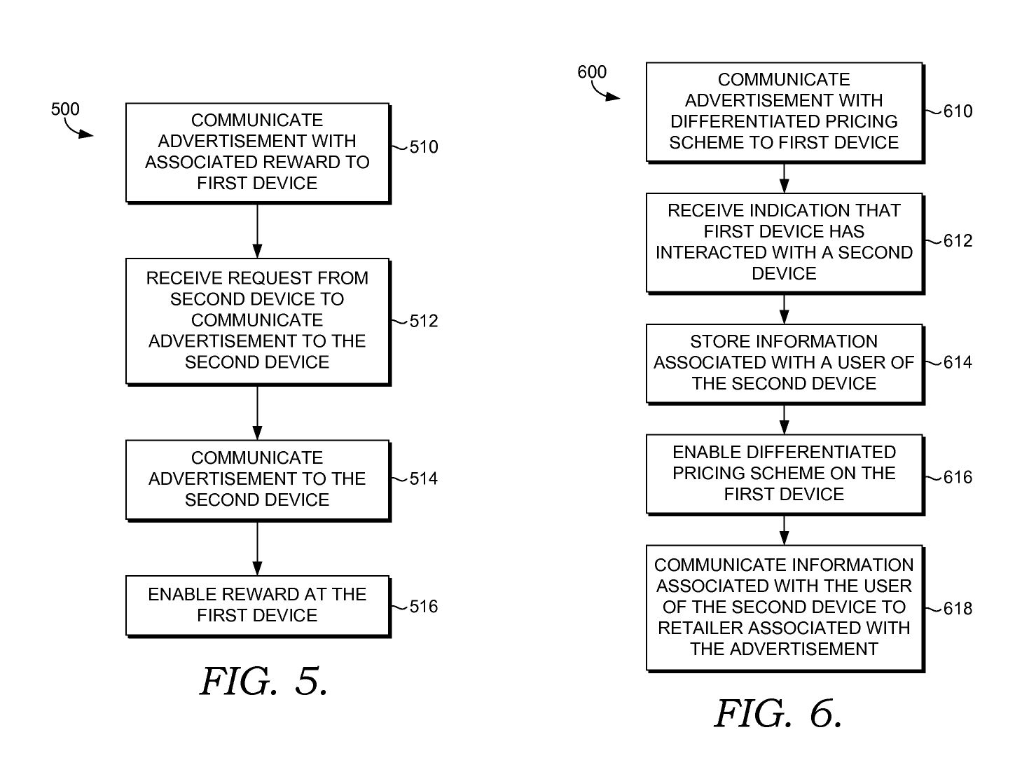

Turning to FIG. 5, flow diagram is depicted of a method of advertising utilizing device-to-device interactions. The flow diagram is referenced generally by the numeral 500. At step 510, an advertisement with an associated reward is communicated to a first device associated with a first user; the reward is enabled at the first device after the advertisement has been communicated from the first device to a predefined number of devices. At step 512, incident to an interaction between the first device and a second device associated with a second user, a request is received from the second device to communicate the advertisement to the second device. At step 514, the advertisement is communicated to the second device. Incident to communicating the advertisement from the first device to the predefined number of devices, each communication of the advertisement incident to an interaction between the first device and a respective one of the predefined number of devices, at step 516 the reward is enabled at the first device.

With respect to FIG. 6, an illustrative flow diagram is depicted of a method of advertising using a differentiated pricing scheme based on a quantity of an item. The flow diagram is referenced by the numeral 600. At step 610, an advertisement that includes the differentiated pricing scheme based on the quantity of the item is communicated to a first device associated with a first user. The advertisement is associated with a retailer. At step 612, an indication is received that the first device has interacted with a second device associated with a second user. At step 614, information associated with the second user is stored. The information includes an identity of the second user and payment information associated with the second user. At step 616, the differentiated pricing scheme is enabled on the first device, and at step 618 the identity of the second user and the payment information associated with the second user is communicated to the retailer associated with the advertisement.

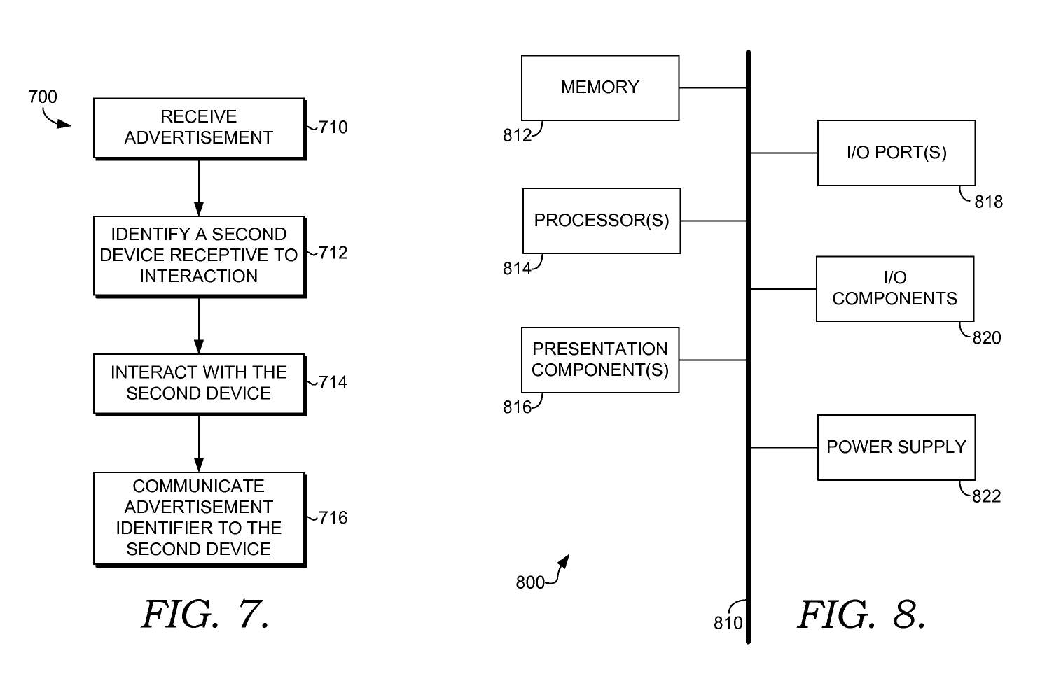

Turning to FIG. 7, an illustrative flow diagram is depicted of a method of advertising using device-to-device interactions and is referenced by the numeral 700. At step 710, an advertisement is received by on the first device. At step 712, the first device identifies a second device that is receptive to interaction. At step 714, the first device interacts with the second device. And at step 716, concurrently with the interaction, an advertisement identifier is communicated from the first device to the second device. The advertisement identifier enables the second device to receive the advertisement.

Exemplary Operating Environment

An exemplary computing environment suitable for use in implementing embodiments of the present invention is described below in order to provide a general context for various aspects of the present invention. Referring to FIG. 8, such an exemplary computing environment is shown and designated generally as computing device 800. The computing device 800 is but one example of a suitable computing environment and is not intended to suggest any limitation as to the scope of use or functionality of embodiments of the invention. Neither should the computing device 800 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules, including routines, programs, objects, components, data structures, etc., refer to code that performs particular tasks or implements particular abstract data types. Embodiments of the invention may be practiced in a variety of system configurations, including hand-held devices, consumer electronics, general-purpose computers, more specialty computing devices, and the like. Embodiments of the invention may also be practiced in distributed computing environments where tasks are performed by remote-processing devices that are linked through a communications network.

With continued reference to FIG. 8, the computing device 800 includes a bus 810 that directly or indirectly couples the following devices: a memory 812, one or more processors 814, one or more presentation components 816, one or more input/output (I/O) ports 818, I/O components 820, and an illustrative power supply 822. The bus 810 represents what may be one or more busses (such as an address bus, data bus, or combination thereof). Although the various blocks of FIG. 8 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 8 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 8 and reference to “computer” or “computing device.”

The computing device 800 typically includes a variety of computer-readable media. Computer-readable media may be any available media that is accessible by the computing device 800 and includes both volatile and nonvolatile media, removable and non-removable media. Computer-readable media comprises computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 812 includes computer-storage media in the form of volatile and/or nonvolatile memory. The memory may be removable, non-removable, or a combination thereof. Exemplary hardware devices include solid-state memory, hard drives, optical-disc drives, and the like. The computing device 800 includes one or more processors that read data from various entities such as the memory 812 or the I/O components 820. The presentation component(s) 816 present data indications to a user or other device. Exemplary presentation components include a display device, speaker, printing component, vibrating component, and the like.

The I/O ports 818 allow the computing device 800 to be logically coupled to other devices including the I/O components 820, some of which may be built in. Illustrative components include a microphone, joystick, game pad, satellite dish, scanner, printer, wireless device, etc.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, a set of one or more processes distributed on one or more computers, one or more stand-alone storage devices, a set of one or more other computing or storage devices, a combination of one or more of the above, and the like.

### CONCLUSION

As can be seen, embodiments of the present invention provide systems, methods, and computer-readable media for, among other things, enabling an advertiser to reward customers who engage in word-of-mouth advertising through device-to-device interactions. For example, a customer may receive an advertisement with an associated reward on his mobile device. The customer can then interact with other mobile devices in such a way as to facilitate the dissemination of the advertisement. After the customer has interacted with a certain number of mobile devices, the reward is enabled and the customer is able to use the reward. In addition, the present invention further leverages device-to-device interactions by enabling an advertiser to create advertisements that take advantage of bulk buying concepts. In this case, a customer can aggregate a set of buyers by utilizing device-to-device interactions. Once the required number of buyers is aggregated, the buyers can buy the items in bulk and take advantage of reduced pricing.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the method 500 of FIG. 25, the method 600 of FIG. 6, and the method 700 of FIG. 7 are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

1. Computer-readable media having computer-executable instructions embodied thereon that, when executed, facilitate a method of advertising utilizing device-to-device interactions, the method comprising:
communicating an advertisement to a first device associated with a first user, wherein the advertisement has an associated reward that is enabled at the first device after the advertisement has been communicated to a predefined number of devices;
incident to an interaction between the first device and a second device associated with a second user, receiving a request from the second device to communicate the advertisement to the second device;
communicating the advertisement to the second device; and
incident to communicating the advertisement to the predefined number of devices, each communication of the advertisement being incident to an interaction between the first device and a respective one of the predefined number of devices, enabling the reward at the first device.

2. The computer-readable media of claim 1 further comprising:
incident to an interaction between the first device and a third device associated with a third user, receiving a request from the third device to communicate the advertisement to the third device;
communicating the advertisement to the third device; and
incident to communicating the advertisement to the predefined number of devices, each communication of the advertisement being incident to an interaction between the first device and a respective one of the predefined number of devices, enabling the reward at the first device.

3. The computer-readable media of claim 1 further comprising:
incident to an interaction between the second device and a third device associated with a third user, receiving a request from the third device to communicate the advertisement to the third device;
communicating the advertisement to the third device; and
incident to communicating the advertisement to the predefined number of devices, each communication of the advertisement being incident to an interaction between the second device and a respective one of the predefined number of devices, enabling the reward at the first device.

4. The computer-readable media of claim 1, wherein the advertisement is communicated to the first device upon determining that the advertisement has not been previously communicated to the first device.

5. The computer-readable media of claim 4, wherein the advertisement is communicated to the first device upon determining that a related advertisement has previously been communicated to the first device, wherein the related advertisement belongs to a same product category as the advertisement.

6. The computer-readable media of claim 1, wherein the advertisement is communicated to the first device in response to user interaction with a set of search results, user interaction with a Web page, or user interaction with a computer application.

7. The computer-readable media of claim 1, wherein the interaction between the first device and the second device is stored as an advertising metric.

8. The computer-readable media of claim 1, wherein prior to the interaction, the first device determines that the second device is receptive to interaction.

9. The computer-readable media of claim 8, wherein the determination is made by establishing a communication path with the second device, the communication path utilizing at least one of short-range wireless radio-frequency communication, near field communication, a local area network, a wide area network, or a cellular phone network.

10. The computer-readable media of claim 9, wherein concurrently with the interaction, data is transferred from the first device to the second device utilizing the communication path.

11. The computer-readable media of claim 10, wherein the transferred data comprises an advertisement identifier associated with the advertisement that is useable by an advertising network to communicate the advertisement to the second device.

12. The computer-readable media of claim 1, wherein the interaction occurs by physically touching the first device to the second device.

13. Computer-readable media having computer-executable instruction embodied thereon that, when executed, facilitate a method of advertising using a differentiated pricing scheme based on a quantity of an item, the method comprising:
communicating an advertisement that includes the differentiated pricing scheme based on the quantity of the item to a first device associated with a first user, wherein the advertisement is associated with a retailer;
receiving an indication that the first device has interacted with a second device associated with a second user;
storing information associated with the second user, the information including an identity of the second user and payment information associated with the second user;
enabling the differentiated pricing scheme on the first device; and
communicating the identity of the second user and the payment information associated with the second user to the retailer associated with the advertisement.

14. The computer-readable media of claim 13 further comprising:
receiving an indication that the first device has interacted with a third device associated with a third user;
storing information associated with the third user, the information including an identity of the third user and payment information associated with the third user;
enabling the differentiated pricing scheme on the first device; and
communicating the identity of the third user and the payment information associated with the third user to the retailer associated with the advertisement.

15. The computer-readable media of claim 13 further comprising:
receiving an indication that the second device has interacted with a third device associated with a third user;
storing information associated with the third user, the information including an identity of the third user and payment information associated with the third user;
enabling the differentiated pricing scheme on the first device; and
communicating the identity of the third user and the payment information associated with the third user to the retailer associated with the advertisement.

16. The computer-readable media of claim 13 further comprising:
notifying the second user:
(A) that the differentiated pricing scheme has been enabled on the first device, and
(B) that the identity of the second user and the payment information associated with the second user has been communicated to the retailer associated with the advertisement.

17. The computer-readable media of claim 13, wherein the information associated with the second user is assigned a code, and wherein the code is communicated to the first device.

18. The computer-readable media of claim 17, wherein the differentiated pricing scheme is enabled on the first device subsequent to the first device communicating the code to the retailer associated with the advertisement.

19. Computer-readable media having computer-executable instruction embodied thereon that, when executed, facilitate a method of advertising using device-to-device interactions, the methods comprising, at a first device:
receiving an advertisement;
identifying a second device that is receptive to interaction;
interacting with the second device; and
concurrently with the interaction, communicating an advertisement identifier associated with the advertisement to the second device, the advertisement identifier enabling the second device to receive the advertisement.

20. The computer-readable media of claim 19, wherein the advertisement is received from an advertising network.
